(19) United States
(12) Patent Application Publication
(10) Pub. No.: US 2012/0310912 A1
(43) Pub. Date: Dec. 6, 2012

(54) CRAWL FRESHNESS IN DISASTER DATA CENTER

(75) Inventors: Siddharth Rajendra Shah, Bothell, WA (US); Arunachalam Thirupathi, Redmond, WA (US); Viktoriya Taranov, Bellevue, WA (US); Daniel Blood, Redmond, WA (US)

(73) Assignee: MICROSOFT CORPORATION, Redmond, WA (US)

(21) Appl. No.: 13/154,283

(22) Filed: Jun. 6, 2011

(51) Int. Cl. G06F 17/30

(52) U.S. Cl. 707/709; 707/E17.108

(57) ABSTRACT

Content that is stored at a secondary location for a service is crawled before it is placed in operation to assist in maintaining an up to date search index. The content that is crawled at the secondary location includes content that is obtained from the primary location of the service. When a crawler at the secondary location attempts to access content that is stored at the primary location, the crawler is directed to access the corresponding copy of the content that is stored at the secondary location instead of accessing the content at the primary location. The content may be crawled at the secondary location at different times, such as when the information is updated, according to a schedule, and the like.

### BACKGROUND

Web-based applications and online services include files that are located on web servers along with data that is stored in databases. A search index may be used by the service to increase the speed and performance of responding to a search query. When the search index is out of date, a search query may not return all of the information that is currently in the service.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Content that is stored at a secondary location for a service is crawled before it is placed in operation to assist in maintaining an up to date search index. The secondary location may act as a disaster data center for the primary location of the service. When a disaster occurs, the secondary location handles the requests for the service in place of the primary location. The content that is crawled at the secondary location includes content that is obtained from the primary location of the service. For example, the content that is stored at the secondary location may include a backup/mirror of the content that is stored at the primary location. When a crawler at the secondary location attempts to access content that is stored at the primary location, the crawler is directed to access the corresponding copy of the content that is stored at the secondary location instead of accessing the content at the primary location. The content may be crawled at the secondary location at different times, such as when the information is updated, according to a schedule, and the like. When a disaster occurs at the primary location of the service and traffic is routed to the secondary location, a user may perform searches and receive search results from the search index created at the secondary location.

### BRIEF DESCRIPTION OF THE DRAWINGS

FIG. 1 illustrates an exemplary computing environment;

FIG. 2 shows a system for maintaining a search index at a secondary location of an online service;

FIG. 3 illustrates a process for creating and updating a search index at a secondary location of a service; and

FIG. 4 shows a directing a request to content at the primary location to a secondary location during a crawl of content at the secondary location.

### DETAILED DESCRIPTION

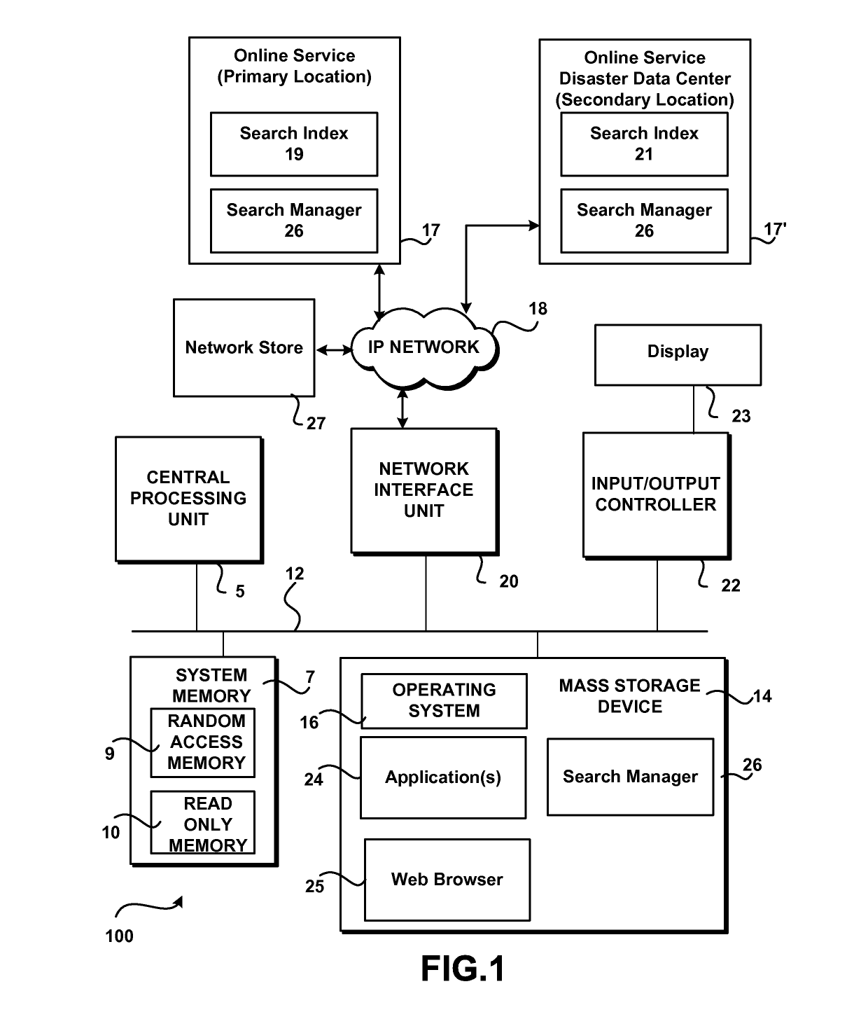

Referring now to the drawings, in which like numerals represent like elements, various embodiment will be described. In particular, FIG. 1 and the corresponding discussion are intended to provide a brief, general description of a suitable computing environment in which embodiments may be implemented.

Generally, program modules include routines, programs, components, data structures, and other types of structures that perform particular tasks or implement particular abstract data types. Other computer system configurations may also be used, including hand-held devices, multiprocessor systems, microprocessor-based or programmable consumer electronics, minicomputers, mainframe computers, and the like. Distributed computing environments may also be used where tasks are performed by remote processing devices that are linked through a communications network. In a distributed computing environment, program modules may be located in both local and remote memory storage devices.

Referring now to FIG. 1, an illustrative computer environment for a computer 100 utilized in the various embodiments will be described. The computer environment shown in FIG. 1 includes computing devices that each may be configured as a mobile computing device (e.g. phone, tablet, net book, laptop), server, a desktop, or some other type of computing device and includes a central processing unit 5 (“CPU”), a system memory 7, including a random access memory 9 (“RAM”) and a read-only memory (“ROM”) 10, and a system bus 12 that couples the memory to the central processing unit (“CPU”) 5.

A basic input/output system containing the basic routines that help to transfer information between elements within the computer, such as during startup, is stored in the ROM 10. The computer 100 further includes a mass storage device 14 for storing an operating system 16, application(s) 24, Web browser 25, and search manager 26 which will be described in greater detail below.

The mass storage device 14 is connected to the CPU 5 through a mass storage controller (not shown) connected to the bus 12. The mass storage device 14 and its associated computer-readable media provide non-volatile storage for the computer 100. Although the description of computer-readable media contained herein refers to a mass storage device, such as a hard disk or CD-ROM drive, the computer-readable media can be any available media that can be accessed by the computer 100.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, Erasable Programmable Read Only Memory (“EPROM”), Electrically Erasable Programmable Read Only Memory (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 100.

Computer 100 operates in a networked environment using logical connections to remote computers through a network 18, such as the Internet. The computer 100 may connect to the network 18 through a network interface unit 20 connected to the bus 12. The network connection may be wireless and/or wired. The network interface unit 20 may also be utilized to connect to other types of networks and remote computer systems. The computer 100 may also include an input/output controller 22 for receiving and processing input from a number of other devices, including a keyboard, mouse, or electronic stylus (not shown in FIG. 1). Similarly, an input/output controller 22 may provide input/output to a display screen 23, a printer, or other type of output device.

As mentioned briefly above, a number of program modules and data files may be stored in the mass storage device 14 and RAM 9 of the computer 100, including an operating system 16 suitable for controlling the operation of a computer, such as the WINDOWS 7®, WINDOWS SERVER®, or WINDOWS PHONE 7® operating system from MICROSOFT CORPORATION of Redmond, Wash. The mass storage device 14 and RAM 9 may also store one or more program modules. In particular, the mass storage device 14 and the RAM 9 may store one or more application programs, including one or more application(s) 24 and Web browser 25. According to an embodiment, application 24 is an application that is configured to interact with on online service, such as a business point of solution service that provides services for different tenants. Other applications may also be used. For example, application 24 may be a client application that is configured to interact with data. The application may be configured to interact with many different types of data, including but not limited to: documents, spreadsheets, slides, notes, and the like.

Network store 27 is configured to store data such as tenant data for tenants of a service, such as online service 17. Network store 27 is accessible to one or more computing devices/users through IP network 18. For example, network store 27 may store tenant data for one or more tenants for an online service, such as online service 17. Other network stores may also be configured to store data for tenants. Tenant data may also move from on network store to another network store. As illustrated, the online service includes a primary location 17 and a secondary location 17′. According to an embodiment, the secondary location 17′ is a mirror of the primary online service 17 and acts as a disaster data center in case of a disaster that affects the accessibility of the primary location of the online service. Generally, the secondary location 17′ provides a copy of the services and data that are provided by the primary online service 17. During normal operation, requests to the online service are directed to the primary location 17. While the primary location is active, content changes and actions that occur in the primary network are mirrored in the secondary location. In this way, the primary location and the secondary location remain configured in the same manner and include substantially the same content. The primary location of the online service 17 and the secondary location 17′ each maintain a search index that is crawled by crawlers that are associated with each of the respective services.

Search manager 26 is configured to maintain a search index for an online service. Search manager 26 may be a part of an online service, such as online service 17 and online service 17′, and all/some of the functionality provided by search manager 26 may be located internally/externally from an application.

Generally, search manager 26 is configured to perform operations relating to the search service for a location of an online service, such as online service 17′. The content that is crawled at the secondary location includes content that is obtained from the primary location of the service. For example, the content that is stored at the secondary location may includes a backup of content that is stored at the primary location. When a crawler at the secondary location attempts to access content that is stored at the primary location (e.g. the URL being crawled points to the primary location), the crawler is directed by the search manager 26 to access the corresponding copy of the content that is stored at the secondary location instead of the content at the primary location. Without redirecting the crawler to the corresponding content at the secondary location, the corresponding search results at the secondary location would not point to the correct URLs when the secondary location becomes the primary location. The content may be crawled at the secondary location at different times. For example, the content may be crawled when the content is updated, according to a schedule, and the like. When a disaster occurs at the primary location of the service and traffic is routed to the secondary location, a user may perform searches and receive search results from the search index 21 that is stored and updated at the secondary location. More details regarding the search manager are disclosed below.

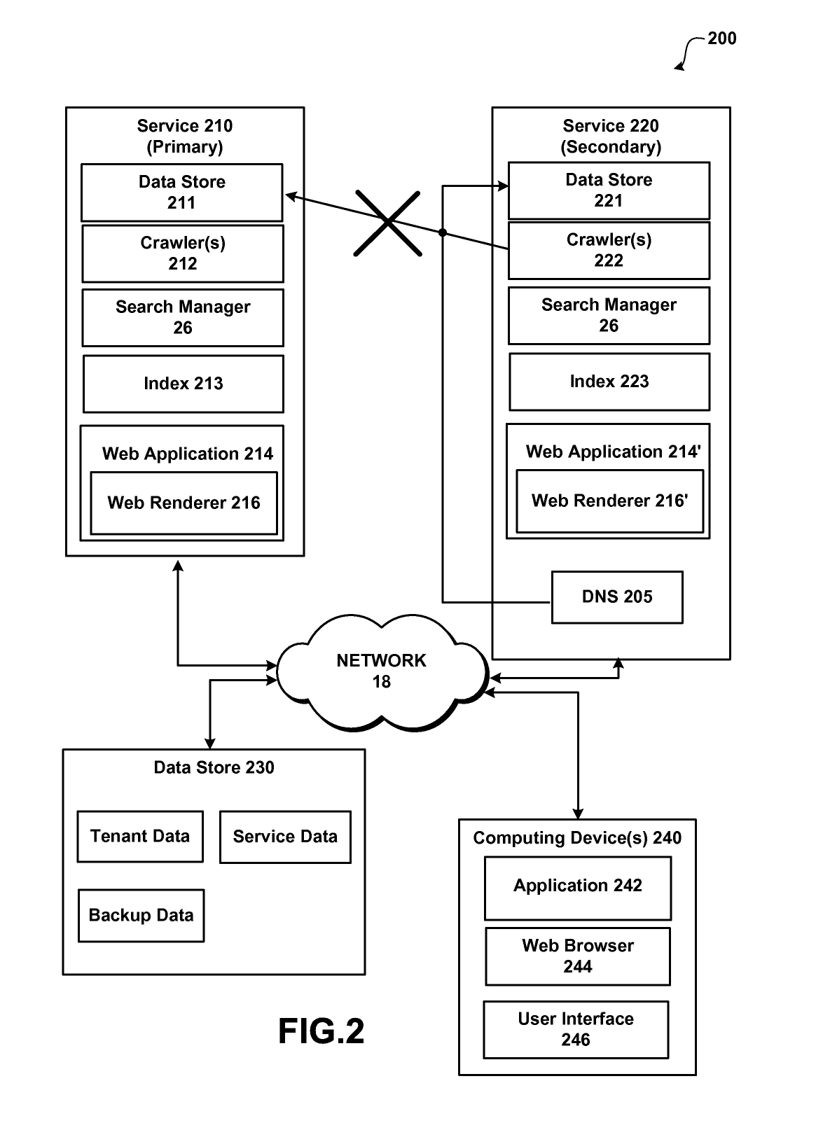

FIG. 2 shows a system for maintaining a search index at a secondary location of an online service. As illustrated, system 200 includes DNS 205, primary service 210, secondary service 220, data store 230 and computing device(s) 240.

The computing devices used may be any type of computing device that is configured to perform the operations relating to the use of the computing device. For example, some of the computing devices may be: mobile computing devices (e.g. cellular phones, tablets, smart phones, laptops, and the like); some may be desktop computing devices and other computing devices may be configured as servers. Some computing devices may be arranged to provide an online cloud based service (e.g. service 210 and service 220), some may be arranged as data shares that provide data storage services, some may be arranged in local networks, some may be arranged in networks accessible through the Internet, and the like.

The computing devices are coupled through network 18. Network 18 may be many different types of networks. For example, network 18 may be an IP network, a carrier network for cellular communications, and the like. Generally, network 18 is used to transmit data between computing devices, such as service 210, service 220, data store 230 and computing device(s) 240.

Computing device(s) 240 includes application 242, Web browser 244 and user interface 246. As illustrated, computing device 240 is used by a user to interact with an online service, such as service 210. According to an embodiment, service 210 and 220 is a multi-tenancy service. Generally, multi-tenancy refers to the isolation of data (sometimes including backups), usage and administration between customers. In other words, data from one customer (tenant 1) is not accessible by another customer (tenant 2) even though the data from each of the tenants may be stored within a same database within the same data store.

User interface (UI) 246 is used to interact with various applications that may be local/non-local to computing device 240. One or more user interfaces of one or more types may be used to interact with content. For example, UI 246 may include the use of a context menu, a menu within a menu bar, a menu item selected from a ribbon user interface, a graphical menu, and the like. Generally, UI 246 is configured such that a user may easily interact with functionality of an application. For example, a user may enter a search query within UI 246 to request content that is maintained by a service, such as online service 210.

Data store 230 is configured to store tenant data. The data stores are accessible by various computing devices. For example, the network stores may be associated with an online service that supports online business point of solution services. For example, an online service may provide data services, word processing services, spreadsheet services, and the like.

As illustrated, data store 230 includes tenant data, including corresponding backup data, for N different tenants. A data store may store all/portion of a tenant's data. For example, some tenants may use more than one data store, whereas other tenants share the data store with many other tenants. While the corresponding backup data for a tenant is illustrated within the same data store, the backup data may be stored at other locations. For example, one data store may be used to store tenant data and one or more other data stores may be used to store the corresponding backup data. Data store 230 may also include data relating to operation of the service (e.g. service 210, service 220). One or more data stores may also be stored within a network of an online service (e.g. data store 211 for primary service 210 and data store 221 for secondary service 220). Generally, the data in data store 221 is a mirror of the data in data store 211 while service 210 is operating as the primary location of the online service. Changes made to data that is associated with the primary service 210 (i.e. data relating to administrative changes and tenant data) is mirrored to the secondary service 220. According to an embodiment, full backups (e.g. weekly), incremental backups (e.g. hourly, daily) and transaction logs are used in maintaining changes made to the primary location. According to an embodiment, the changes made to the primary service are copied to the secondary service such that the secondary service remains substantially synchronized with the primary service (e.g. within five, ten minutes). Periodically, the data that is copied to the secondary service is verified to help ensure that the data has been correctly copied. Different methods may be used to perform the verification (e.g. checksums, hash functions, and the like).

Services 210 and 220 include data store 211 and 221, crawler(s) 212 and 222, search manager 26, index 213 and 223, and Web application 214 and 214′ that comprises Web renderer 216 and 216′. Service 210 is configured as an online service that is configured to provide services relating to displaying an interacting with data from multiple tenants. Service 210 provides a shared infrastructure for multiple tenants. According to an embodiment, the service 210 is MICROSOFT'S SHAREPOINT ONLINE service. Different tenants may host their Web applications/site collections using service 210. Web application 214 is configured for receiving and responding to requests relating to data. For example, service 210 may access a tenant's data that is stored on data store 212 and/or data store 230. Web application 214 is operative to provide an interface to a user of a computing device, such as computing device 240, to interact with data accessible via network 18. Web application 214 may communicate with other servers that are used for performing operations relating to the service. A computing device may transmit a request to interact with a document, and/or other data that is associated with service 210.

Crawler(s) 212 are configured to maintain search index 213 that is used by a search tool for service 210. Generally, crawler 212 examines content that is stored in service 210 (e.g. in data store 211 and/or data store 230) and updates index 213 that is used in responding to search queries. Secondary service 220 includes its own crawler(s) 222 and search tool apart from service 210. Crawler(s) 222 maintain search index 223 that is used by a search tool associated with service 220 for responding to requests from a user. For example, index 223 would be used in responding to a search query from a user after requests are transferred to the secondary location after a disaster occurs that affects the operation of the primary location for the service. When crawler 222 is indexing the content (e.g. content in data store 221), the crawler may encounter content that is linked to a location of the primary service. For example, assume that rayspizza.spo.com is a tenant of the online service. When the tenant directly types “http://rayspizza.spo.com” in their favorite browser, they are redirected to the primary site because of the DNS being registered on the internet. If the same URL is navigated to from one of the crawler machines at the secondary location, however, the request is directed to the location of the content at the secondary location. According to an embodiment, the request by the crawler does not hit the internet DNS and is instead intercepted by a local DNS (e.g. DNS 205) and re-routed to a local load-balancer (not shown) which points the request to a local Web Front End (WFE) that is at the secondary location. According to another embodiment, a hosts file entry is created on the crawler machines to point tenant URLs to machine IPs that exist at the secondary location instead of the primary location.

DNS 205 provides an address of content to a crawler 222 that is indexing the content. When a crawler is crawling content at the secondary location, DNS 205 receives the request and directs the request to the secondary service 220. The content at the primary location is backed up and mirrored to the secondary location. In this way, the crawler may create an index for content stored at the secondary location. The search index 223 at the secondary service 220 remains substantially synchronized with the index 213 at the primary location even though each search index is created and updated independently by each service. When a disaster occurs and requests are redirected to the secondary location, a user may perform a query to index 223 that is up to date relative to the last content that was received from the primary service 210.

In response to receiving a request at a service, Web application 214 obtains the data from a location, such as network share 230 and/or some other data store. The data to display is converted into a markup language format, such as the ISO/IEC 29500 format. The data may be converted by service 210 or by one or more other computing devices. Once the Web application 214 has received the markup language representation of the data, the service utilizes the Web renderer 216 to convert the markup language formatted document into a representation of the data that may be rendered by a Web browser application, such as Web browser 244 on computing device 240. The rendered data appears substantially similar to the output of a corresponding desktop application when utilized to view the same data. Once Web renderer 216 has completed rendering the file, it is returned by the service 210 to the requesting computing device where it may be rendered by the Web browser 244.

The Web renderer 216 is also configured to render into the markup language file one or more scripts for allowing the user of a computing device, such as computing device 240 to interact with the data within the context of the Web browser 244. Web renderer 216 is operative to render script code that is executable by the Web browser application 244 into the returned Web page. The scripts may provide functionality, for instance, for allowing a user to change a section of the data and/or to modify values that are related to the data. In response to certain types of user input, the scripts may be executed. When a script is executed, a response may be transmitted to the service 210 indicating that the document has been acted upon, to identify the type of interaction that was made, and to further identify to the Web application 214 the function that should be performed upon the data.

According to an embodiment, the secondary service 220 remains active in a read only mode even when it is not receiving requests such that the secondary service is readily available to service requests when a temporary disaster occurs and requests are automatically directed to the secondary service.

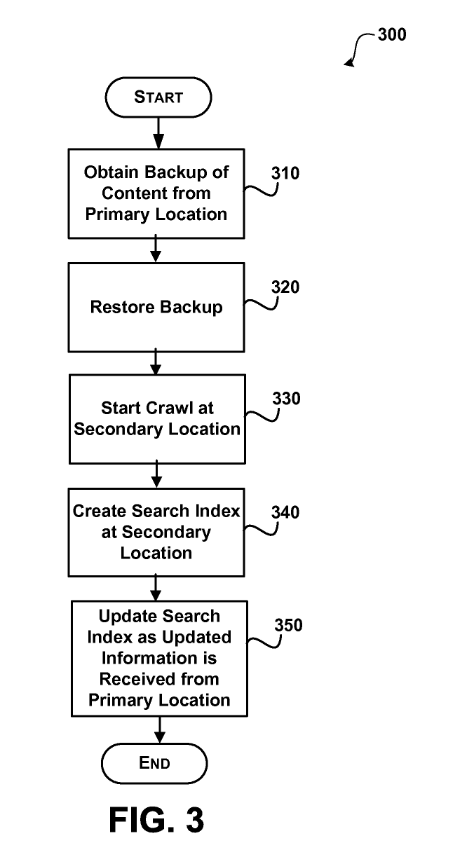

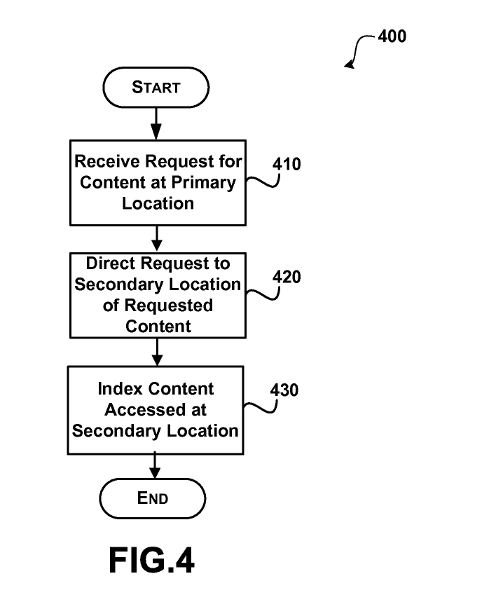

FIGS. 3 and 4 show an illustrative process for creating and maintaining a search index at a secondary location of a service. When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments described herein are referred to variously as operations, structural devices, acts or modules. These operations, structural devices, acts and modules may be implemented in software, in firmware, in special purpose digital logic, and any combination thereof.

FIG. 3 illustrates a process for creating and updating a search index at a secondary location of a service.

After a start block, process 300 moves to operation 310, where a backup of content is received from the primary location. According to an embodiment, a backup of the search content from the primary location is created and received on a weekly basis. Not crawling the obtained content at the secondary location could result in the search index being a week old when a disaster occurs at the primary location. For example, a backup of search content may be obtained on a Saturday and the following Friday a disaster may occur at the primary location causing the content added between Saturday and Friday to be stale within the search index.

Flowing to operation 320, the backup is restored at the secondary location. Restoring the backup results in the content from the primary location being stored at the secondary location.

Moving to operation 330, the crawl is started at the secondary location. The crawl may be started immediately and automatically after the backup is restored and/or at other times (e.g. according to a predetermined schedule, a user action, and the like). Generally, when a crawler requests content from the primary location, the request is directed to obtain the content that has been stored at the secondary location (See FIG. 4 and related discussion).

Transitioning to operation 340, the search index is created at the secondary location. According to an embodiment, each service (the primary and the secondary) include their own search service that maintains its own search index.

Moving to operation 350, the search index at the secondary location is updated as content is received from the primary location.

The process then flows to an end block and returns to processing other actions.

FIG. 4 shows a directing a request to content at the primary location to a secondary location during a crawl of content at the secondary location.

After a start block, process 400 moves to operation 410 where a request is received for content that is located at the primary location. Since the content at the primary location is synchronized with the secondary location, the same content substantially exists at the secondary location. According to an embodiment, the copy of the content at the secondary location is verified to help ensure that the content is copied correctly from the primary location to the secondary location.

Flowing to operation 420, the received request is directed to the secondary location. According to an embodiment, the received request is automatically directed by a DNS to the location of the content at the secondary location such that crawler believes it is accessing the content at the primary location. According to another embodiment, a configuration file may be maintained that points the crawler machines to the secondary locations such that they do not access an Internet DNS and get redirected to the primary location of the service.

Moving to operation 430, the content at the secondary location is indexed at the secondary location.

The process then flows to an end block and returns to processing other actions.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for creating and maintaining a search index at a secondary location that serves as a disaster data center for a primary location of a service, comprising:
obtaining content from the primary location of the service that reflects changes made to the primary location;
storing the content at the secondary location of the service; and
crawling the content that is stored at the secondary location of the service to create a search index at the secondary location before a disaster occurs at the primary location of the service.

2. The method of claim 1, wherein crawling the content that is stored at the secondary location comprises determining when content is requested from the primary location and directing the request to obtain the content from the secondary location instead of the primary location.

3. The method of claim 2, wherein directing the request to the secondary location instead of the primary location comprises changing a DNS (Domain Name System) entry from a primary network address to a secondary network address of the secondary location.

4. The method of claim 2, wherein directing the request from the primary location to the secondary location occurs before a request is made to a DNS outside of the secondary location.

5. The method of claim 2, wherein directing the request to the secondary location instead of the primary location comprises accessing a file at the secondary location that directs a crawler machine at the secondary location to a location at the secondary location.

6. The method of claim 1, wherein obtaining the content from the primary location of the service comprises obtaining a backup of content from the primary location.

7. The method of claim 6, further comprising receiving updates of changes made at the primary location since a time of the backup.

8. The method of claim 1, wherein the secondary location of the service is substantially a mirror of the primary location of the online service that comprises a copy of content of the primary location and remains accessible before and after a disaster at the primary location.

9. The method of claim 1, further comprising verifying an integrity of the obtained content from the primary location.

10. A computer-readable storage medium storing computer-executable instructions for creating and maintaining a search index at a secondary location that serves as a disaster data center for a primary location of a service, comprising:
periodically obtaining content from the primary location of the service that reflects changes made to the primary location;
storing the content at the secondary location of the service such that the content at the secondary location substantially mirrors content at the primary location; and
crawling the content that is stored at the secondary location of the service to create a search index at the secondary location before a disaster occurs at the primary location of the service.

11. The computer-readable storage medium of claim 10, wherein crawling the content that is stored at the secondary location comprises determining when content is requested from the primary location and directing the request to obtain the content from the secondary location instead of the primary location.

12. The computer-readable storage medium of claim 11, wherein directing the request to the secondary location instead of the primary location comprises changing a DNS (Domain Name System) entry from a primary network address to a secondary network address of the secondary location.

13. The computer-readable storage medium of claim 11, wherein directing the request from the primary location to the secondary location occurs before a request is made to a DNS outside of the secondary location.

14. The computer-readable storage medium of claim 11, wherein directing the request to the secondary location instead of the primary location comprises accessing a file at the secondary location that directs a crawler machine at the secondary location to a location at the secondary location.

15. The computer-readable storage medium of claim 10, further comprising creating a new search index in response to receiving a full backup of content from the primary location.

16. The computer-readable storage medium of claim 10, further comprising verifying an integrity of the obtained content from the primary location.

17. A system for creating and maintaining a search index at a secondary location that serves as a disaster data center for a primary location of a service, comprising:
a network connection that is configured to connect to a network;
a processor, memory, and a computer-readable storage medium;
an operating environment stored on the computer-readable storage medium and executing on the processor;
a data store storing data that is associated with different tenants; and
a search manager operating that is configured to perform actions comprising:
periodically obtaining content from the primary location of the service that reflects changes made to the primary location;
storing the content in the data store of the secondary location of the service such that the content at the secondary location substantially mirrors content at the primary location; and
crawling the content that is stored at the secondary location of the service to create a search index at the secondary location before a disaster occurs at the primary location of the service.

18. The system of claim 17, wherein crawling the content that is stored at the secondary location comprises determining when content is requested from the primary location and directing the request to obtain the content from the secondary location instead of the primary location.

19. The system of claim 18, wherein directing the request to the secondary location instead of the primary location comprises changing a DNS (Domain Name System) entry from a primary network address to a secondary network address of the secondary location.

20. The system of claim 18, wherein directing the request to the secondary location instead of the primary location comprises accessing a file at the secondary location that directs a crawler machine at the secondary location to a location at the secondary location.
